(19) United States
(12) Patent Application Publication
(10) Pub. No.: US 2015/0262074 A1
(43) Pub. Date: Sep. 17, 2015

(54) SOLVING DIGITAL LOGIC CONSTRAINT PROBLEMS VIA ADIABATIC QUANTUM COMPUTATION

(71) Applicant: Temporal Defense Systems, LLC, Renton, WA (US)

(72) Inventors: Jeremy BRUESTLE, Seattle, WA (US); Mark TUCKER, Kirkland, WA (US)

(21) Appl. No.: 14/656,420

(22) Filed: Mar. 12, 2015

Related U.S. Application Data
(60) Provisional application No. 61/952,049, filed on Mar. 12, 2014.

(51) Int. Cl. G06N 99/00; G06F 9/30

(52) U.S. Cl. CPC G06N 99/002; G06F 9/30185; G06F 9/30003

(57) ABSTRACT

A constraint problem may be represented as a digital circuit comprising at least one gate and at least one constrained input or at least one constrained output, or a combination of at least one constrained input and at least one constrained output. A matrix may be generated for each of the at least one gates. A constraint matrix may be generated for the at least one constrained input, the at least one constrained output, or the combination of at least one constrained input and at least one constrained output. A final matrix comprising a combination of each matrix for each of the at least one gates and the constraint matrix may be generated. The final matrix may be translated into an energy representation useable by a quantum computer. The energy of the energy representation may be minimized to generate a q-bit output, and a result of the constraint problem may be determined based on the q-bit output.

### CROSS-REFERENCE TO RELATED APPLICATION

This disclosure claims priority from U.S. Provisional Application No. 61/952,049, entitled “Method for Solving Digital Logic Constraint Problems Via Adiabatic Quantum Computation,” filed Mar. 12, 2014, the entirety of which is incorporated by reference herein.

### BRIEF DESCRIPTION OF THE DRAWINGS

FIG. 1 shows a system comprising a classical computer and a quantum computer according to an embodiment of the invention.

FIG. 2 shows a table of gate types according to an embodiment of the invention.

FIG. 3a shows a process flow diagram according to an embodiment of the invention.

FIG. 3b shows a process flow diagram according to an embodiment of the invention.

FIG. 4 shows an adder circuit in canonical form according to an embodiment of the invention.

FIG. 5 shows an adder circuit with intermediate outputs numbered according to an embodiment of the invention.

FIG. 6 shows an adder circuit with gates numbered according to an embodiment of the invention.

FIG. 7 shows an adder circuit as a table according to an embodiment of the invention.

FIG. 8 shows an example permutation matrix for G11 according to an embodiment of the invention.

FIG. 9 shows an example gate matrix for G11 according to an embodiment of the invention.

FIG. 10 shows a final matrix computation for G11 according to an embodiment of the invention.

FIG. 11 shows a matrix for an entire circuit according to an embodiment of the invention.

FIG. 12 shows a constraint matrix according to an embodiment of the invention.

FIG. 13 shows a circuit matrix with constraints added according to an embodiment of the invention.

### DETAILED DESCRIPTION OF SEVERAL EMBODIMENTS

Many practical optimization problems may be computationally expensive to solve with classical computers and algorithms. These optimization problems may require finding values for a set of variables such that some value is minimized or maximized or a set of constraints is satisfied. These problems are called NP-Hard problems in the art. For example, scheduling problems, resource utilization problems, and routing problems may all be examples of such NP-Hard problems. The form of these constraints and the nature of the variables involved may differ, but they all may be represented as a Boolean function (or circuit) acting on bits. Even when the problems are represented as logic circuits suitable for interpretation by a classical computer, finding missing information may be computationally expensive and/or practically impossible (e.g., one-way functions where only the output is known and the input is desired).

Systems and methods described herein may be used to solve constraint or optimization problems involving binary variables and arbitrary Boolean functions via quantum computing. The problem and any constraints may be converted into a form useable as an input to a quantum computer so that the quantum computer can find a solution. The form may be an energy representation, and the quantum computer may minimize the energy in the energy representation to find the solution. For example, the input may be a Hamiltonian matrix suitable for evaluation by an adiabatic quantum computer such that the lowest energy state of the Hamiltonian matrix represents the solution to the problem. The problem may be represented as a digital logic circuit along with a set of constraints. The constraints may be defined values (e.g., known or desired inputs or outputs for the problem), and in some embodiments the constraints may be single-bit constraints. One or more inputs, one or more outputs, or a combination of one or more inputs and one or more outputs may be constrained. The circuit may be converted to a canonical form, q-bits (quantum bits) may be assigned to each circuit path, a matrix representing the circuit may be generated, the constraints may be applied to reduce the matrix, the lowest energy state may be found via the quantum computer, and the resulting state may be interpreted in light of the original problem. Thus, by applying the systems and methods described herein, any problem that can be expressed as a logic circuit may be evaluated using a quantum computer.

Some embodiments may include a classical computer and associated software, which may accept the problem definition (e.g., the logic circuit and constraints), perform the needed translations, and interpret the results. Such embodiments may also include a quantum computer (e.g., an adiabatic quantum computer or other quantum computer) which may perform the energy minimization.

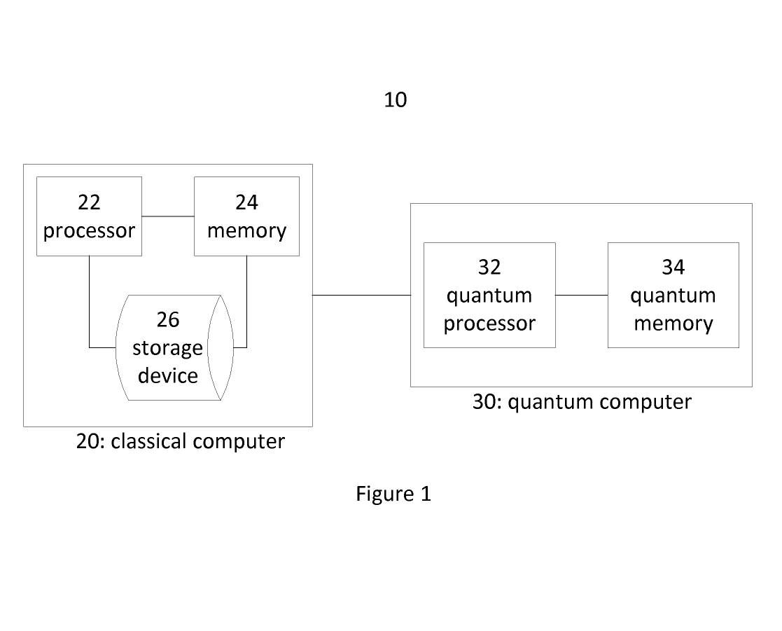

FIG. 1 shows a system 10 comprising a classical computer 20 and a quantum computer 30 according to an embodiment of the invention. The classical computer 20 may be any programmable digital machine or machines capable of performing arithmetic and/or logical operations using bits. In some embodiments, the classical computer 20 may comprise one or more processors 22, memories 24, data storage devices 26, and/or other commonly known or novel components. These components may be connected physically or through network or wireless links. The classical computer 20 may also comprise software which may direct the operations of the aforementioned components.

The classical computer 20 may comprise a plurality of classical computers linked to one another via a network or networks in some embodiments. A network may be any plurality of completely or partially interconnected classical computers and/or quantum computers wherein some or all of the classical computers and/or quantum computers are able to communicate with one another. It will be understood by those of ordinary skill that connections between classical computers and/or quantum computers may be wired in some cases (e.g., via Ethernet, coaxial, optical, or other wired connection) or may be wireless (e.g., via Wi-Fi, WiMax, or other wireless connection). Connections between classical computers and/or quantum computers may use any protocols, including connection-oriented protocols such as TCP or connectionless protocols such as UDP. Any connection through which at least two classical computers and/or quantum computers may exchange data can be the basis of a network.

The quantum computer 30 may be any programmable quantum machine or machines capable of performing arithmetic and/or logical operations using q-bits. In some embodiments, the quantum computer 30 may comprise one or more quantum processors 32, quantum memories 34, and/or other commonly known or novel components. These components may be connected physically or through network or wireless links. The quantum computer 30 may also comprise software which may direct the operations of the aforementioned components. The quantum computer 30 may comprise a plurality of quantum computers linked to one another via a network or networks in some embodiments. The quantum computer 30 may be linked to the classical computer 20 so the quantum computer 30 and classical computer 20 can exchange data. The quantum computer 30 used in the examples discussed herein is an adiabatic quantum computer using the Ising model, although other types of quantum computers may be used in some embodiments (e.g., quantum computers using the Quadratic Unconstrained Binary Optimization (QUBO) model).

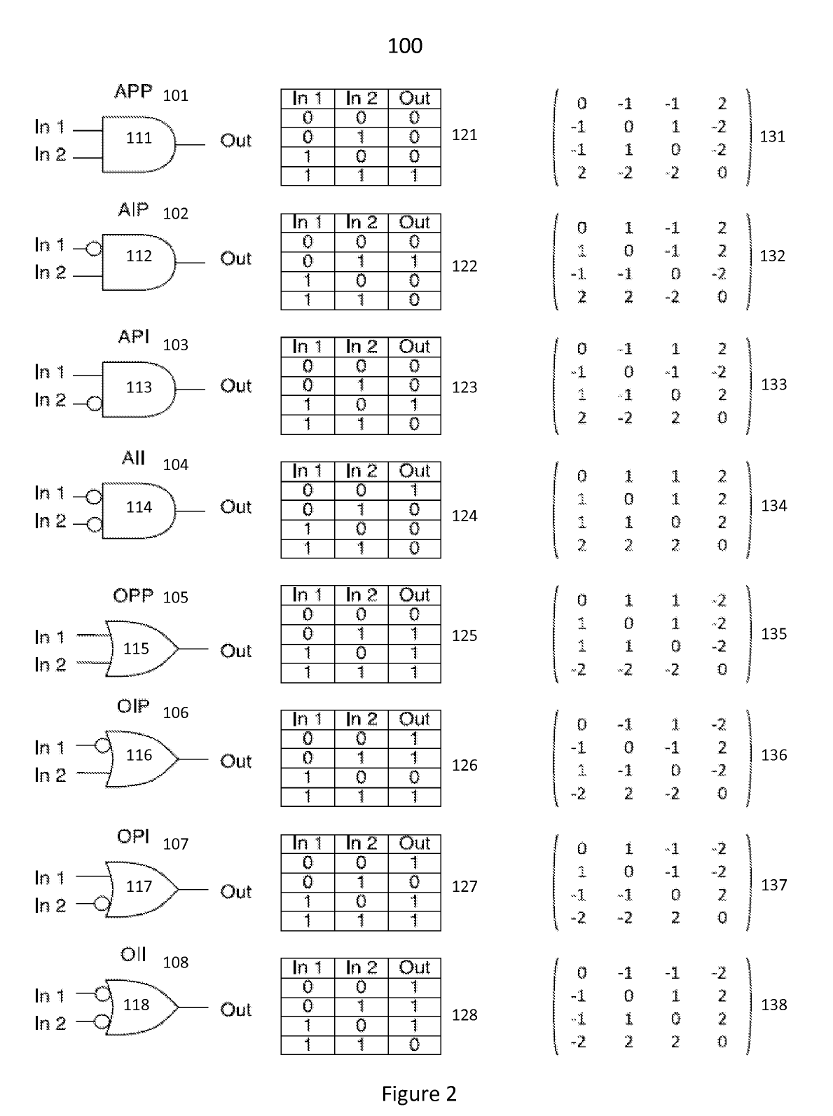

By converting a problem expressed as a logic circuit and a set of constrained inputs and/or outputs into a form that can be analyzed by a quantum computer, NP-hard problems wherein some or all inputs are unknown (e.g., one-way functions wherein only the output is available) may be solvable. For example, in addition to the example discussed with respect to FIGS. 2-13 below, the systems and methods described herein may be applied to solve problems associated with a variety of different systems. Such problems may include finding pre-images for cryptographic hash functions such as SHA-1 (secure hash algorithm) wherein the hash function is defined as a circuit and the output of the hash function is constrained, computing the plain text of a cryptographic algorithm such as AES (advanced encryption standard) wherein the algorithm is defined as a circuit and the constraints include a subset of the bits of the key and the cipher text, and other computationally expensive problems such as the traveling salesman problem which can be applied to a variety of problems including manufacturing and delivery.

A problem to be solved may first be converted to a representation as a digital circuit, along with a set of single bit constraints applied to either the inputs, the outputs, or some combination of both inputs and outputs of the circuit. Because the constraints may be applied to the input, the output, or some combination of the two, systems and methods described herein may be used to convert ordinary gate logic into a form suitable for use in quantum computing, as well as to perform search, inversion, or other general constraint satisfaction problems. For example, to emulate ordinary digital logic within a quantum-computing environment, the inputs may be specified (constrained), and the outputs may be found. Alternately, to search for a set of inputs that satisfies a set of outputs, the outputs may be specified (constrained), and the inputs may be found. Many use cases may specify (constrain) both some inputs and some outputs. The example below uses a two bit full adder as the digital circuit under consideration and specifies the first input to be 2 and specifies the output to be 5, with the desire to discover that the second input should be 3. This is a simplified example to illustrate the disclosed problem-solving processes, and those of ordinary skill in the art will appreciate that any logic, inputs, and/or outputs may be used. Specific practical applications of the process are discussed after the simple example is presented.

FIG. 2 shows a table 100 of gate types according to an embodiment of the invention. Some sets of gates may be functionally complete, meaning that all possible circuits can be made of a combination of gates from that set. For example, one functionally complete set of gates may comprise the ‘and’ and ‘not’ gates. For the purposes of the example circuit described herein, a specific set of gates that is functionally complete is defined, which is referred to herein as the ‘canonical gates’. The names 101-108, symbols 111-118, and truth tables 121-128 for the example set of canonical gates are shown in FIG. 2, along with an energy representation (e.g., energy matrix 131-138) for each gate that will be described in greater detail below. In some embodiments, other sets of gates may be used.

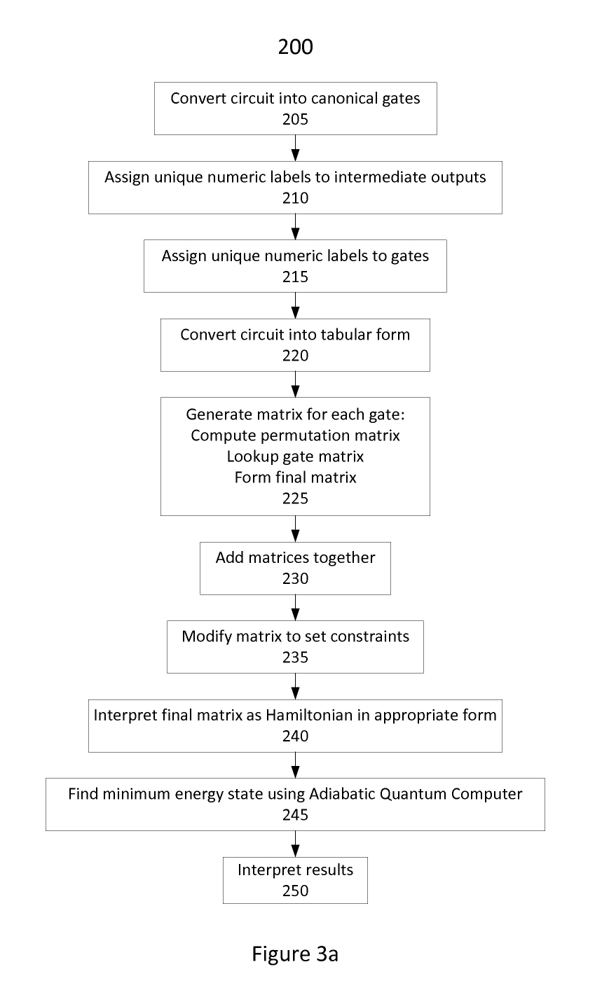

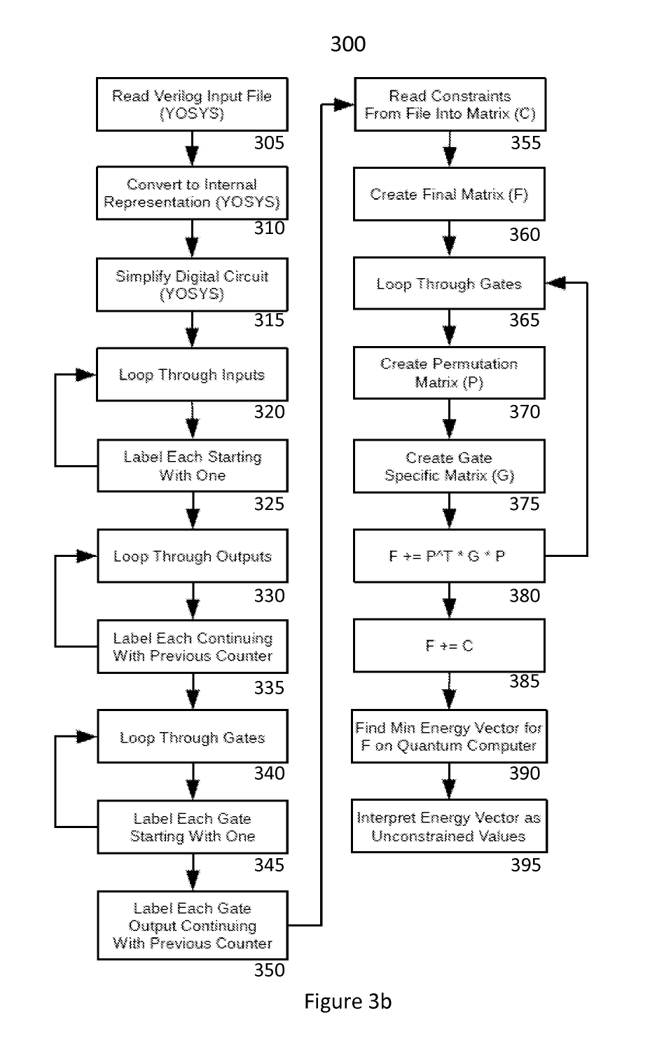

FIG. 3a illustrates a high-level process 200 of solving the constraint system according to an embodiment of the invention. FIG. 3b illustrates a specific implementation 300 of the process 200 according to an embodiment of the invention. In the example associated with these processes 200/300 described below, some actions are described as being performed by the classical computer 20, and other actions are described as being performed by the quantum computer 30. Those of ordinary skill in the art will appreciate that any of the listed actions may be performed by either the classical computer 20 or the quantum computer 30 in some embodiments. Embodiments wherein only a quantum computer 30 is used to perform the entire process 200 may be possible. Embodiments wherein only a classical computer 20 is used to perform the entire process 200 may also be possible.

A digital circuit may be converted into a form comprising only the canonical gates 205 by the classical computer 20, and the resulting circuit may be optimized by the classical computer 20 in some embodiments. For example, a Verilog file containing a digital circuit may be input into an editing tool such as Yosys 305, as shown in FIG. 3b. Optimizations may occur by combining combinations of linear gates into a single or set of non-linear gates. Optimizations may also occur by removing gates where constants are supplied as one of the inputs. Other optimizations well known in the art of electrical engineering and computer science may be applied as well. For example, the Verilog source file may be converted to a Yosys internal representation 310. Then, the Yosys editor may apply optimizations 315 (e.g., by removing never-active circuit branches or other unused elements, consolidating Boolean operation trees, merging identical cells, removing and/or simplifying elements with constant inputs, etc.). Converting circuits between various sets of functionally complete gates may be performed using any of the well-known processes within the art of electrical engineering, for example.

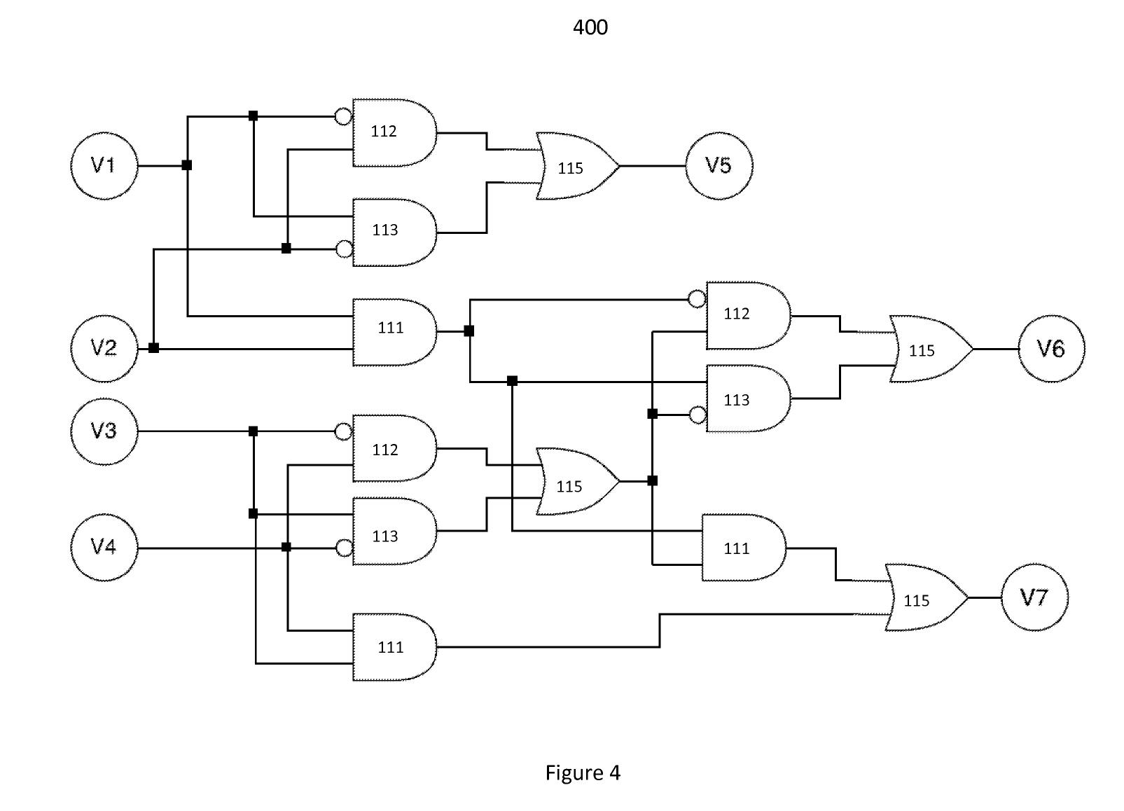

FIG. 4 illustrates a two bit adder after its conversion to the canonical gates 400 according to an embodiment of the invention. In this example, V1 and V2 are respectively the low and high bit of the first number, V3 and V4 are respectively the low and high bit of the second number, and V5, V6, and V7 are the bits of the sum of the two numbers from low bit to high bit. Each input and output has also been given a unique number (V1-V7). As shown in FIG. 3b, the classical computer 20 may loop through the inputs 320 and label each input starting with one 325 (i.e., V1 in this example).

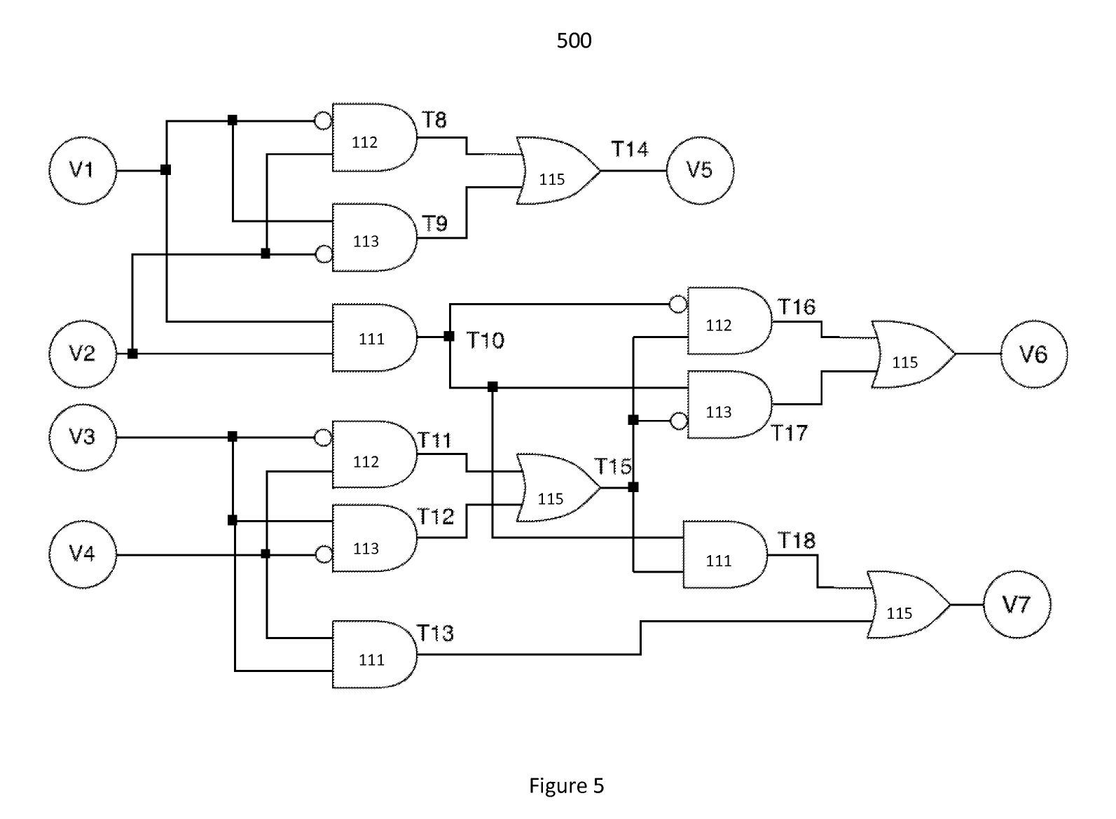

Returning to FIG. 3a, a unique number may be assigned to each intermediate output of the gate logic which is not also a final output 210 by the classical computer 20, beginning with the first number following the highest input or output number. The specific order of these intermediate labels may be arbitrary but may remain consistent throughout the remainder of the process. As shown in FIG. 3b, the classical computer 20 may loop through the outputs 330 and label each output starting with the next number in the counter after the previous labeling operations 335. FIG. 5 illustrates a two bit adder after the intermediate output numbers are assigned 500 according to an embodiment of the invention.

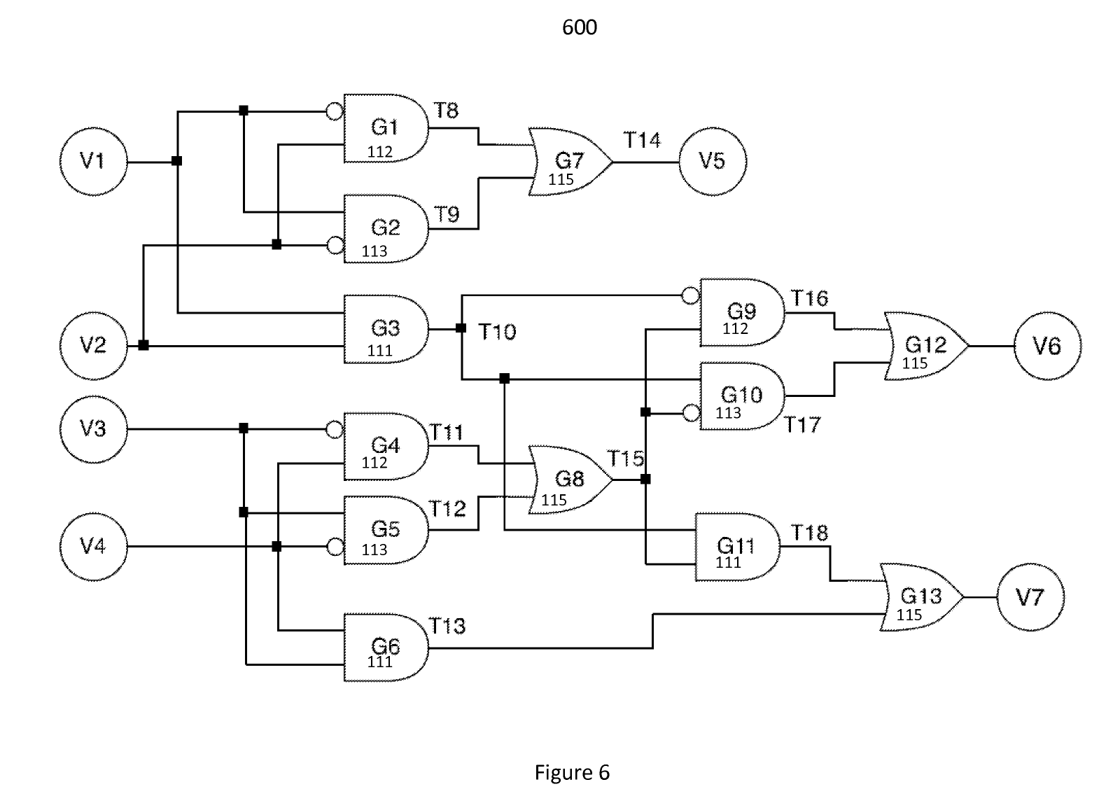

Returning to FIG. 3a, a unique number may be assigned to each gate 215 by the classical computer 20 beginning at the number one. As shown in FIG. 3b, the classical computer 20 may loop through the gates 340 and label each gate starting with one 345. The classical computer 20 may also label each gate output starting with the next number in the counter after the previous labeling operations 350. Again, the specific order may be arbitrary but may remain consistent throughout the remainder of the process. FIG. 6 illustrates a feed-forward adder after the gate numbers are assigned 600 according to an embodiment of the invention.

Returning to FIG. 3a, the representation of the circuit may be converted into a tabular form 220 by the classical computer 20. To accomplish the conversion, each gate may be considered in turn, and the following elements may be determined:
The number of the gate
The type of the gate
The number of the gate's first input
The number of the gate's second input
The number of the gate's output.

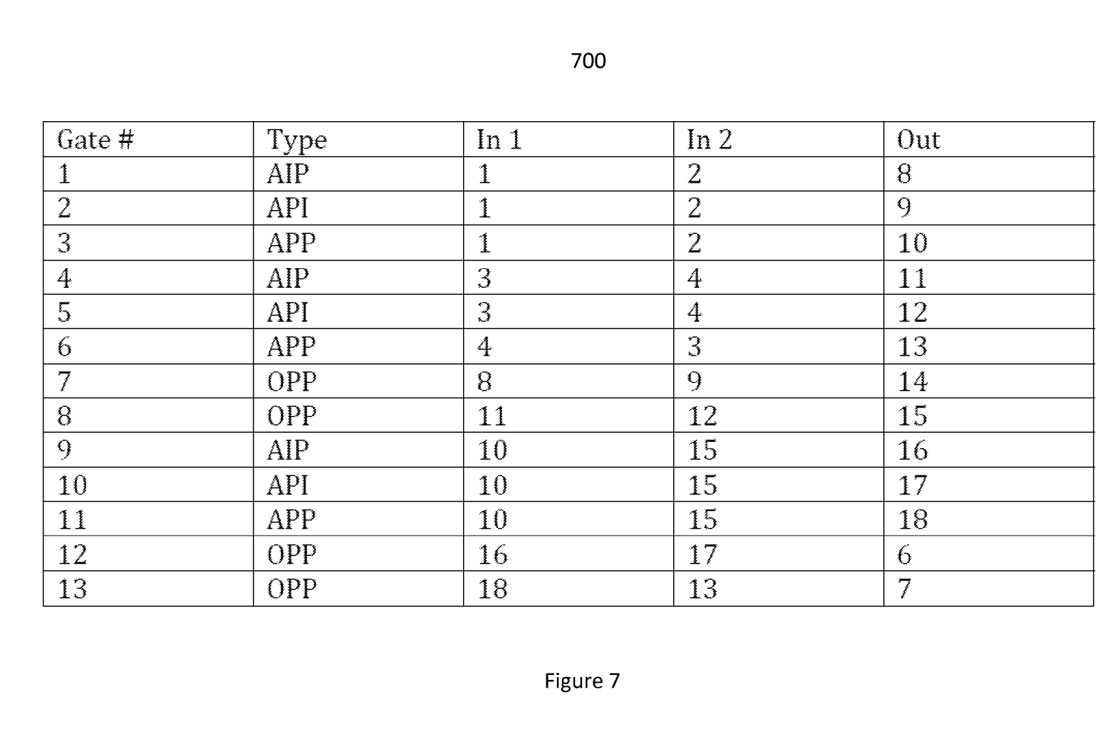

When finding the number associated with the inputs and outputs of gates, V# and T# may be treated identically (that is, primary inputs and output, as well as intermediate outputs, may all be part of a joint numbering scheme). The resulting data points may be placed into a table. FIG. 7 illustrates a feed-forward adder in table form 700 according to an embodiment of the invention. For example, in FIG. 7, gate G11's number is eleven, its type is APP, its first input is ten, its second input is fifteen, and its output is seventeen.

Returning to FIG. 3a, a matrix may be generated for each gate 225 by the classical computer 20. Each gate matrix may be square, with dimensions of one more than the sum of the inputs, outputs, and intermediate outputs; nineteen in the example. To simplify the description of matrices in the rest of the document, the sum of the inputs, outputs, and intermediate outputs is labeled as N. To compute the matrix for a gate, a permutation matrix may be computed, a gate matrix lookup may be performed, and a final matrix may be formed.

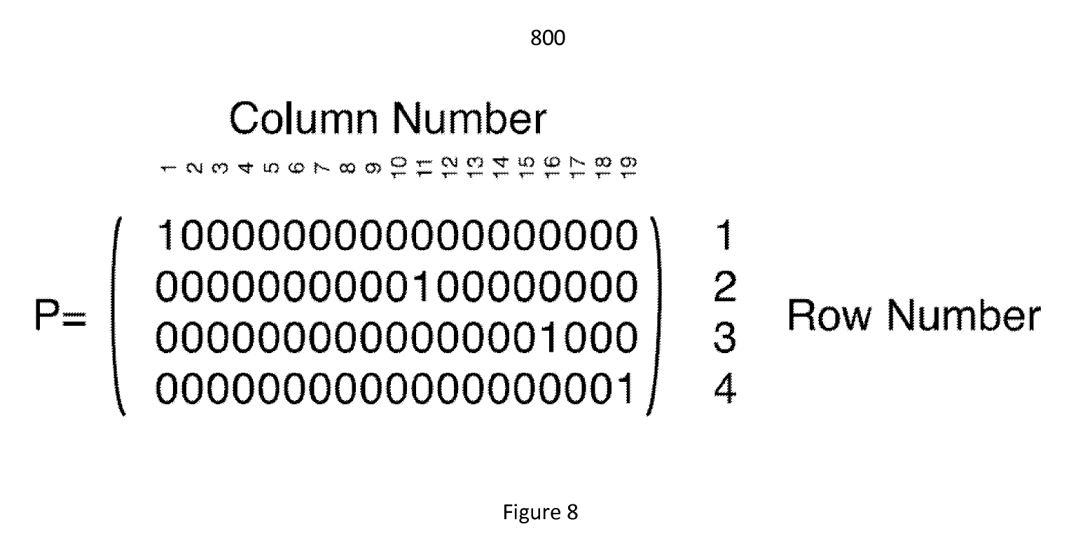

FIG. 8 is a permutation matrix 800 for G11 according to an embodiment of the invention. To compute the matrix, a 4 by (N+1) matrix may be initialized to all zeros, and the following elements may be set to 1:
(1,1)
(2, In 1+1), where In 1 is the number found in the table generated in 220 for the gate in question
(3, In 2+1), where In 2 is the number found in the table generated in 220 for the gate in question
(4, Out+1), where Out is the number found in the table generated in 220 for the gate in question.

A 4 by (N+1) matrix may be used because there may always be 2 inputs and 1 output to any digital gate in the set of canonical gates, plus an “always 1” bit.

According to the table 700 of FIG. 7, for gate G11 the following matrix elements may be set to 1:
(1,1)
(2, 10+1)=(2, 11)
(3, 15+1)=(3, 16)
(4,18+1)=(4, 19).

Thus, the permutation matrix 800 for G11 is shown in FIG. 8.

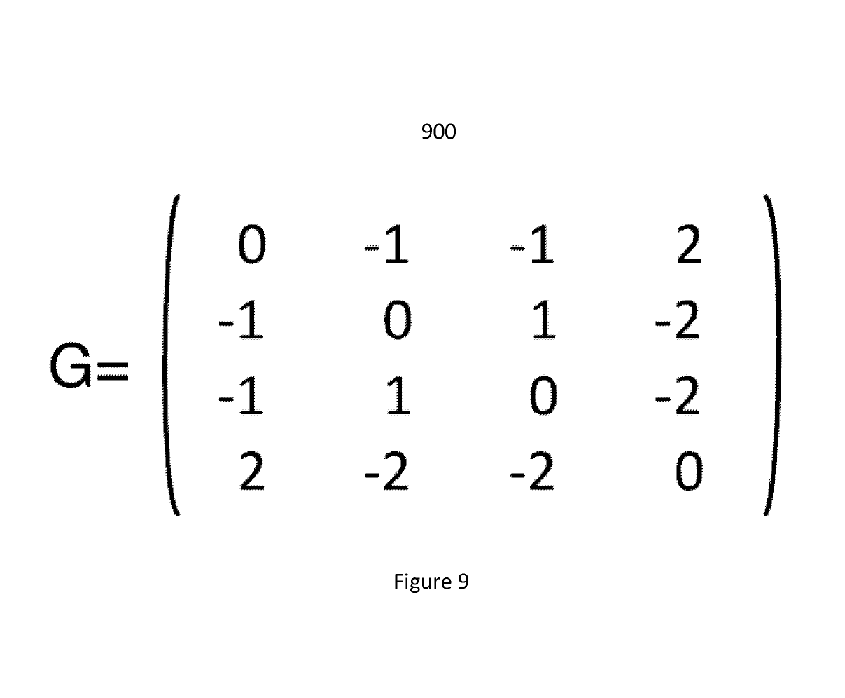

FIG. 9 is a gate matrix 900 for G11 according to an embodiment of the invention. To perform a gate matrix lookup, the appropriate gate matrix for the gate in question may be chosen. This matrix may be chosen based on the type of the gate according to the table of gate types 100 of FIG. 2, for example. Specifically, for each type of gate, the appropriate gate matrix 131-138 is shown to the right of the gate's truth table 121-128 in FIG. 2. Thus, for gate G11, which is of type APP, the first gate matrix 131 may be chosen, as shown in FIG. 9.

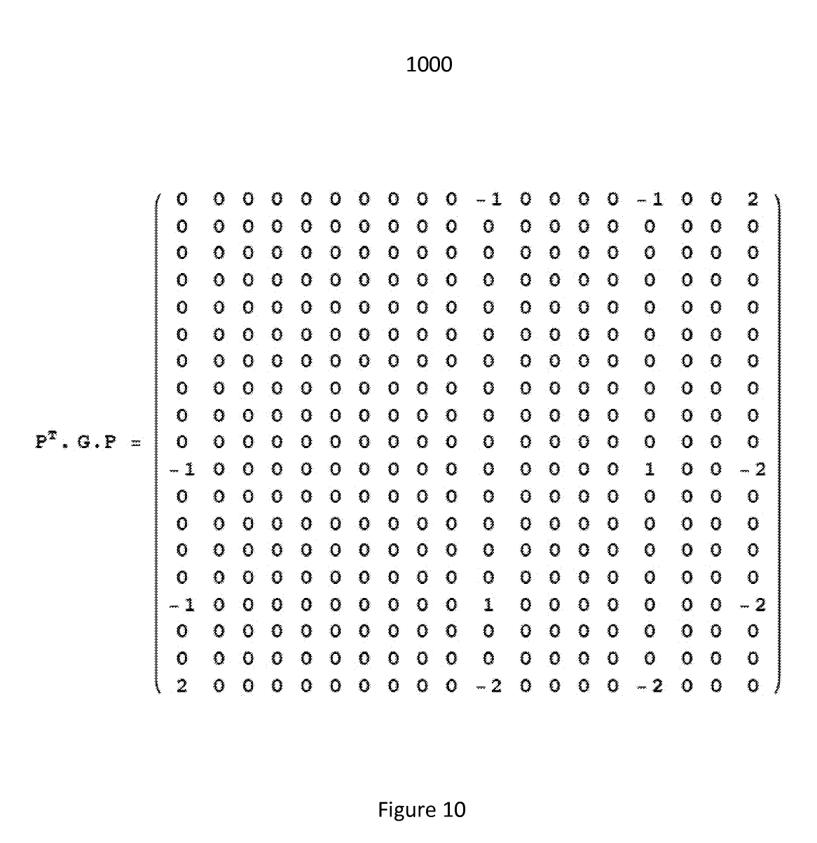

FIG. 10 is a final matrix computation 1000 for G11 according to an embodiment of the invention. To form the final matrix, the transpose of the permutation matrix, the gate matrix, and the permutation matrix again may be multiplied in order. That is: M=P̂T G P. This is shown for gate G11 in FIG. 10.

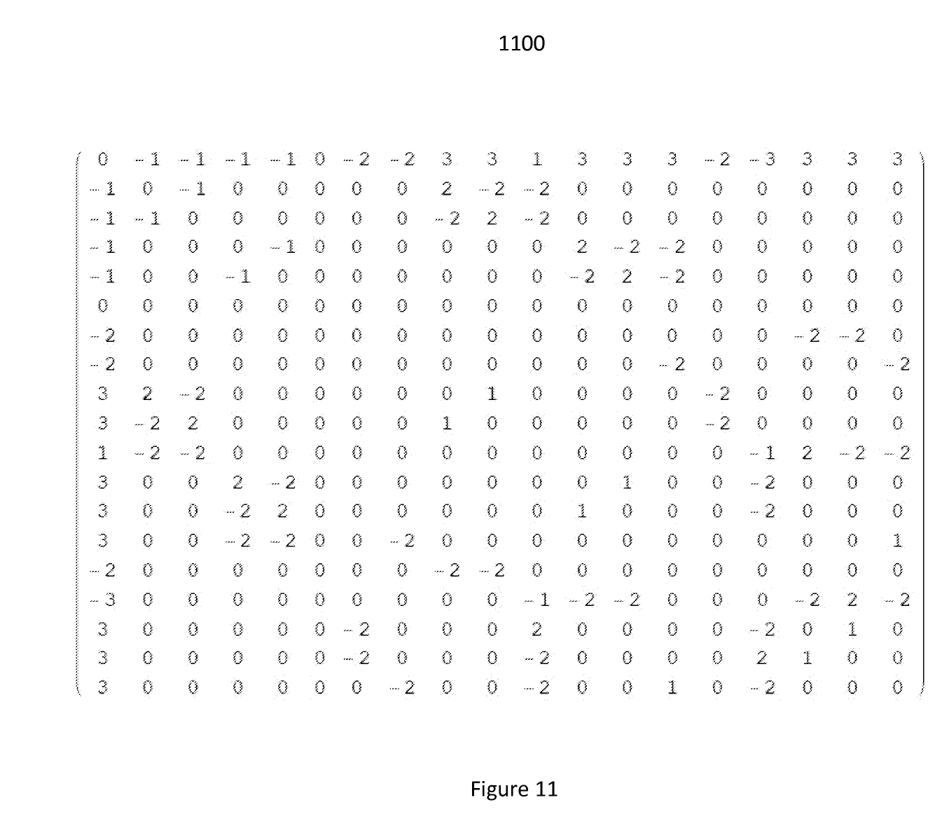

Returning to FIG. 3a, a matrix may be generated 225 for each gate, thus producing one matrix per gate. When each gate has a matrix, the matrixes may be summed together 230 by the classical computer 20. For the example circuit, the resulting matrix 1100 is shown in FIG. 11.

Returning to FIG. 3a, the matrix may be modified by the classical computer 20 to specify the constraints on inputs and outputs 235. A constraint matrix C of size (N+1) by (N+1) initialized to all Os may be constructed. For each input or output to be constrained to the value of 1, (1, x+1) and (x+1,1) may be set to −1, where x is the index of the input or output. For each input or output to be constrained to a value of 0, (1, x+1) and (x+1, 1) may be set to +1, where x is the index of the input or output. Thus, to require the first input of the example adder circuit to be 2 and the output to be 5, the following set of constraints may be applied:
V1=0
V2=1
V5=1
V6=0
V7=1

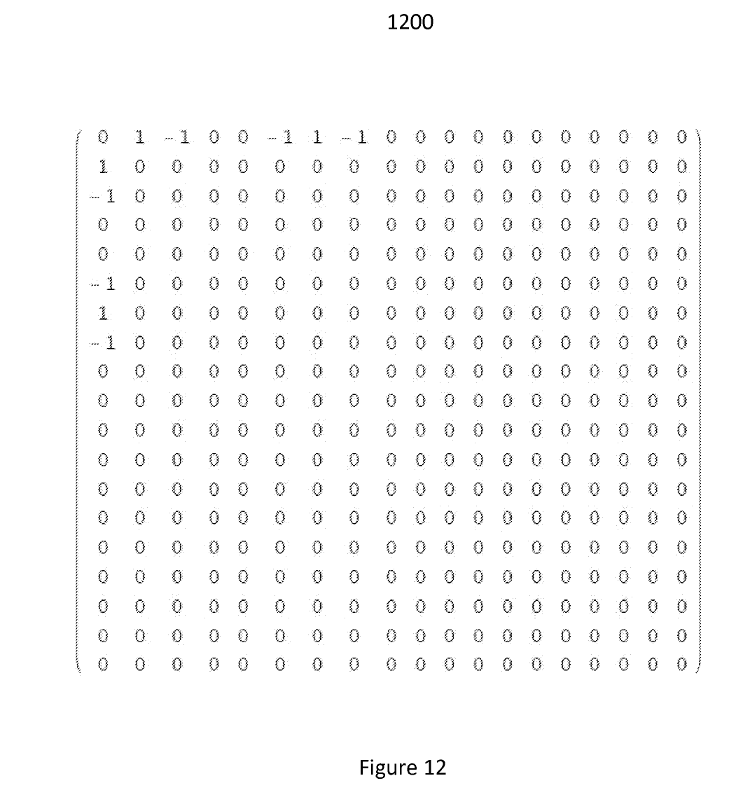

These example constraints are represented by the matrix 1200 shown in FIG. 12.

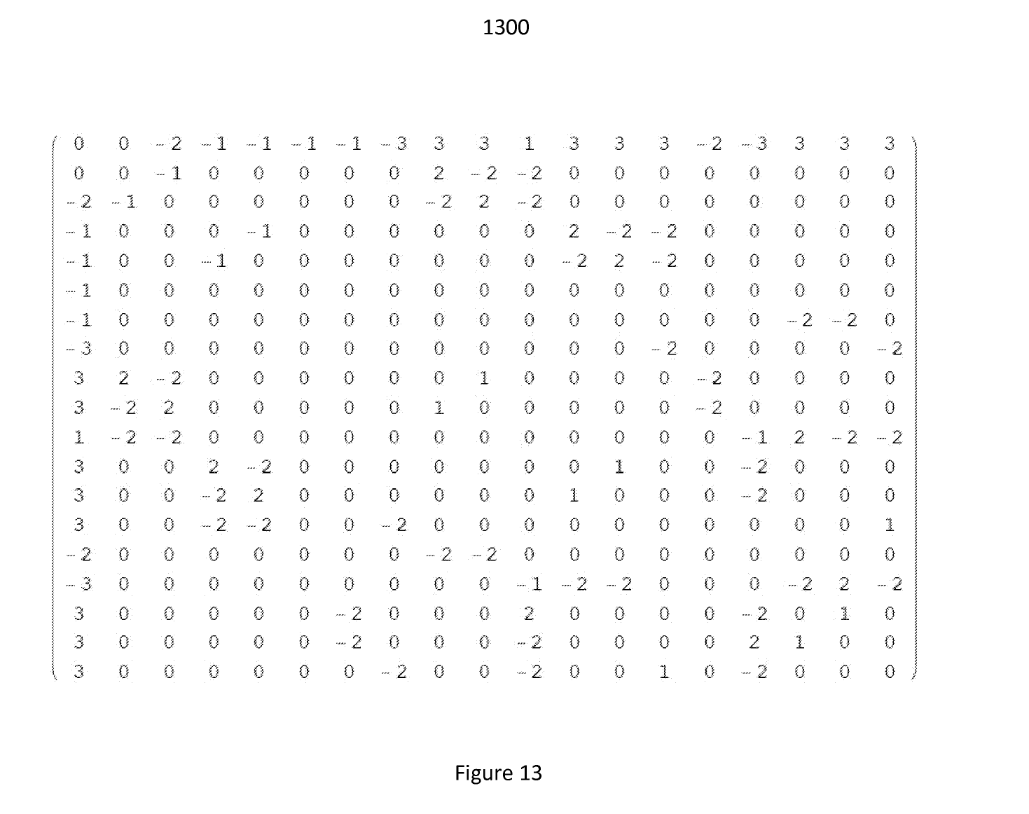

To complete the constraint specification 235, the constraint matrix may be added to the circuit matrix by the classical computer 20, resulting in the final matrix 1300 shown in FIG. 13, for example.

Creation of the final matrix may also proceed as shown in FIG. 3b. Constraints may be read from a file into a constraint matrix C 335. The final matrix F may be created 360, although at this point the final matrix F may not yet be computed. The classical computer 20 may loop through the gates 365 and create each permutation matrix P 370 and gate matrix G 375. The transpose of the permutation matrix, the gate matrix, and the permutation matrix again may be multiplied in order 380. When this process is complete for all gates, the constraint matrix may be added to the circuit matrix 385.

Returning to FIG. 3a, the final matrix may be interpreted as a Hamiltonian matrix 240 or other energy representation. The final matrix, interpreted as a Hamiltonian matrix, may be provided as input to a system that can compute the low energy state. In this model, assume N+1 q-bits. For each q-bit, the state of the q-bit may be either spin up (+1) or spin down (−1). Calling each q-bit state Sᵢ, and the final matrix just computed as M, the total energy of the system may be defined as:

E=Σᵢ₌₁^{N}Σⱼ₌₁^{N}M_{i,j}SᵢSⱼ

The Hamiltonian matrix may be converted into the appropriate form for the specific quantum computer being used by the classical computer 20. If the adiabatic quantum computer uses a spin glass model, conversion may be unnecessary. While a Hamiltonian matrix is the appropriate form for entry into the quantum computer 30 in this example (i.e., the appropriate energy representation of the problem), those of ordinary skill in the art will appreciate that other energy representations may be used in some embodiments. For example, the final matrix may be interpreted as a set of operations of q-bits, a set of quantum gates, or a set of quantum gate operations, or any other format used by a quantum computer 30. In some embodiments (e.g., QUBO embodiments), each q-bit may be +1 or 0 instead of spin up or spin down.

The energy of the Hamiltonian matrix or other energy representation may be minimized 245 by the quantum computer 30, and the output q-bits, Sᵢ may be retrieved from the quantum computer 30 by the classical computer 20. For example, as shown in FIG. 3b, a minimum energy vector for final matrix F may be found 390.

Returning to FIG. 3a, the results may then be interpreted 250 by the classical computer 20. Each q-bit output, which may be either +1 or −1, may be multiplied by the value of the first q-bit, S₁. The first q-bit may be ignored. As shown in FIG. 2b, the minimum energy vector may be interpreted as unconstrained values 395. To find the values for desired inputs or outputs of the circuit, for each input or output index n, the output q-bit, Sₙ₊₁ may be examined. If the q-bit is +1, we may conclude that the input or output has a value of 1. If the q-bit is −1, we may conclude that the input or output has a value of 0.

The example described above illustrates the process 200 of FIG. 3a for a specific problem solving scenario. Those of ordinary skill in the art will appreciate that the same process 200 may be applied to any optimization or constraint problem and, while the circuits, tables, matrices, energy states, etc. may be different, the process 200 may be carried out in similar fashion.

For example, the process 200 of FIG. 3a may be applied to find a pre-image of an SHA-1 cryptographic hash function or other hash function. In this example, the hash function may be converted to a circuit with canonical gates 205, labeled 210-215, converted into tabular form 220, and converted into a matrix 225-230. The output may be constrained (e.g., to a known output of the hash function), and the constrained output may be applied to the matrix 235. The final matrix may be interpreted 240, the minimum energy state may be found 245, and the interpreted results may reveal the pre-image for the hash function 250.

In another example, the process 200 of FIG. 3a may be applied to find a plain text of an AES cryptographic algorithm or other cryptographic algorithm. In this example, the cryptographic algorithm may be converted to a circuit with canonical gates 205, labeled 210-215, converted into tabular form 220, and converted into a matrix 225-230. The constraints may be defined (e.g., a known input subset of the bits of the key and an output cipher text), and the constraints may be applied to the matrix 235. The final matrix may be interpreted 240, the minimum energy state may be found 245, and the interpreted results may reveal the plain text for the cryptographic algorithm 250.

The process 200 of FIG. 3a may also be applied to a traveling salesman problem. For example, a circuit with canonical gates may define a set of locations and travel distances between the locations 205. The circuit may be labeled 210-215, converted into tabular form 220, and converted into a matrix 225-230. Constraints may include a set of locations to visit and a total time allotted for all the visits, which may both be inputs to the circuit. The constrained inputs may be applied to the matrix 235. The final matrix may be interpreted 240, the minimum energy state may be found 245, and the interpreted results may include one or more possible routes or, if no routes are possible in the allotted time, an indication that no routes are possible 250. If no routes are possible, the constraints may be changed to a smaller list of locations or an increased allotted time, and the process 200 may be repeated.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method of formatting a constraint problem for input to a quantum processor and solving the constraint problem, the method comprising:
representing, with a classical processor, a quantum processor, or a combination thereof, the constraint problem as a digital circuit comprising at least one gate and at least one constrained input, at least one constrained output, or a combination of at least one constrained input and at least one constrained output;
generating, with the classical processor, the quantum processor, or the combination thereof, a matrix for each of the at least one gates;
generating, with the classical processor, the quantum processor, or the combination thereof, a constraint matrix for the at least one constrained input, the at least one constrained output, or the combination of at least one constrained input and at least one constrained output;
generating, with the classical processor, the quantum processor, or the combination thereof, a final matrix comprising a combination of each matrix for each of the at least one gates and the constraint matrix;
translating, with the classical processor, the quantum processor, or the combination thereof, the final matrix into an energy representation useable by the quantum processor.
minimizing, with the quantum processor, an energy of the energy representation to generate a quantum bit (q-bit) output; and
determining, with the classical processor, the quantum processor, or the combination thereof, a result of the constraint problem based on the q-bit output.

2. The method of claim 1, wherein the translating comprises interpreting the final matrix as a Hamiltonian energy matrix.

3. The method of claim 2, wherein the Hamiltonian energy matrix comprises a spin glass Hamiltonian energy matrix.

4. The method of claim 2, wherein the Hamiltonian energy matrix represents each of the at least one constrained inputs, each of the at least one constrained outputs, or each of the combination of at least one constrained input and at least one constrained output as a row and column entry in the Hamiltonian energy matrix.

5. The method of claim 2, further comprising converting, with the classical processor, the quantum processor, or the combination thereof, the Hamiltonian energy matrix into an appropriate form for the quantum computer used to minimize the energy of the Hamiltonian energy matrix.

6. The method of claim 1, wherein the representing further comprises assigning a label to each of a plurality of intermediate outputs within the digital circuit.

7. The method of claim 1, wherein the representing further comprises assigning a label to each of the at least one gates.

8. The method of claim 1, wherein the digital circuit comprises at least one two-input logic gate selected from a set of universal gates.

9. The method of claim 8, wherein the set of universal gates comprises eight two-input gates formed by all two-input combinations of AND and OR with optional NOT functionality on one or both of the inputs.

10. The method of claim 1, wherein the digital circuit comprises at least one sub-circuit that evaluates to true when constraints on an input are satisfied and an output of the sub-circuit is constrained to be true.

11. The method of claim 1, further comprising converting, with the classical processor, the quantum processor, or the combination thereof, the digital circuit into a table comprising data about the at least one gate and the at least one constrained input, the at least one constrained output, or the combination of at least one constrained input and at least one constrained output.

12. The method of claim 1, wherein generating the matrix for each of the at least one gates comprises:
computing a permutation matrix for the gate;
choosing a gate matrix based on a gate type of the gate; and
multiplying a transpose of the permutation matrix, the gate matrix, and the permutation matrix to form the matrix for the gate.

13. The method of claim 1, wherein generating the final matrix comprises:
adding each matrix for each of the at least one gates together to create a circuit matrix; and
adding the constraint matrix to the circuit matrix.

14. The method of claim 1, wherein the quantum processor uses adiabatic quantum computing.

15. The method of claim 1, wherein the digital circuit represents a cryptographic function, a cryptographic algorithm, or a traveling salesman problem.

16. The method of claim 15, wherein the cryptographic function is a one-way function.

17. A system for formatting a constraint problem for input to a quantum computer and solving the constraint problem, the system comprising:
a classical computer configured to:
represent the constraint problem as a digital circuit comprising at least one gate and at least one constrained input, at least one constrained output, or a combination of at least one constrained input and at least one constrained output;
generate a matrix for each of the at least one gates;
generate a constraint matrix for the at least one constrained input, the at least one constrained output, or the combination of at least one constrained input and at least one constrained output;
generate a final matrix comprising a combination of each matrix for each of the at least one gates and the constraint matrix; and
translate the final matrix into an energy representation useable by the quantum computer; and
the quantum computer configured to:
minimize an energy of the energy representation to generate a quantum bit (q-bit) output;
wherein the classical computer is further configured to determine a result of the constraint problem based on the q-bit output.

18. The system of claim 17, wherein the translating comprises interpreting the final matrix as a Hamiltonian energy matrix.

19. The system of claim 18, wherein the Hamiltonian energy matrix comprises a spin glass Hamiltonian energy matrix.

20. The system of claim 18, wherein the Hamiltonian energy matrix represents each of the at least one constrained inputs, each of the at least one constrained outputs, or each of the combination of at least one constrained input and at least one constrained output as a row and column entry in the Hamiltonian energy matrix.

21. The system of claim 18, wherein the classical computer is further configured to convert the Hamiltonian energy matrix into an appropriate form for the quantum computer used to minimize the energy of the Hamiltonian energy matrix.

22. The system of claim 17, wherein the representing further comprises assigning a label to each of a plurality of intermediate outputs within the digital circuit.

23. The system of claim 17, wherein the representing further comprises assigning a label to each of the at least one gates.

24. The system of claim 17, wherein the digital circuit comprises at least one two-input logic gate selected from a set of universal gates.

25. The system of claim 24, wherein the set of universal gates comprises eight two-input gates formed by all two-input combinations of AND and OR with optional NOT functionality on one or both of the inputs.

26. The system of claim 17, wherein the digital circuit comprises at least one sub-circuit that evaluates to true when constraints on an input are satisfied and an output of the sub-circuit is constrained to be true.

27. The system of claim 17, wherein the classical computer is further configured to convert the digital circuit into a table comprising data about the at least one gate and the at least one constrained input, the at least one constrained output, or the combination of at least one constrained input and at least one constrained output.

28. The system of claim 17, wherein generating the matrix for each of the at least one gates comprises:
computing a permutation matrix for the gate;
choosing a gate matrix based on a gate type of the gate; and
multiplying a transpose of the permutation matrix, the gate matrix, and the permutation matrix to form the matrix for the gate.

29. The system of claim 17, wherein generating the final matrix comprises:
adding each matrix for each of the at least one gates together to create a circuit matrix; and
adding the constraint matrix to the circuit matrix.

30. The system of claim 17, wherein the quantum computer uses adiabatic quantum computing.

31. The system of claim 17, wherein the digital circuit represents a cryptographic function, a cryptographic algorithm, or a traveling salesman problem.

32. The system of claim 31, wherein the cryptographic function is a one-way function.

33. A quantum computer configured to:
represent a constraint problem as a digital circuit comprising at least one gate and at least one constrained input, at least one constrained output, or a combination of at least one constrained input and at least one constrained output;
generate a matrix for each of the at least one gates;
generate a constraint matrix for the at least one constrained input, the at least one constrained output, or the combination of at least one constrained input and at least one constrained output;
generate a final matrix comprising a combination of each matrix for each of the at least one gates and the constraint matrix;
translate the final matrix into an energy representation useable by the quantum computer;
minimize an energy of the energy representation to generate a quantum bit (q-bit) output; and
determine a result of the constraint problem based on the q-bit output.

34. The quantum computer of claim 33, wherein the translating comprises interpreting the final matrix as a Hamiltonian energy matrix.

35. The quantum computer of claim 34, wherein the Hamiltonian energy matrix comprises a spin glass Hamiltonian energy matrix.

36. The quantum computer of claim 34, wherein the Hamiltonian energy matrix represents each of the at least one constrained inputs, each of the at least one constrained outputs, or each of the combination of at least one constrained input and at least one constrained output as a row and column entry in the Hamiltonian energy matrix.

37. The quantum computer of claim 34, wherein the quantum computer is further configured to convert the Hamiltonian energy matrix into an appropriate form for the quantum computer used to minimize the energy of the Hamiltonian energy matrix.

38. The quantum computer of claim 33, wherein the representing further comprises assigning a label to each of a plurality of intermediate outputs within the digital circuit.

39. The quantum computer of claim 33, wherein the representing further comprises assigning a label to each of the at least one gates.

40. The quantum computer of claim 33, wherein the digital circuit comprises at least one two-input logic gate selected from a set of universal gates.

41. The quantum computer of claim 40, wherein the set of universal gates comprises eight two-input gates formed by all two-input combinations of AND and OR with optional NOT functionality on one or both of the inputs.

42. The quantum computer of claim 33, wherein the digital circuit comprises at least one sub-circuit that evaluates to true when constraints on an input are satisfied and an output of the sub-circuit is constrained to be true.

43. The quantum computer of claim 33, wherein the quantum computer is further configured to convert the digital circuit into a table comprising data about the at least one gate and the at least one constrained input, the at least one constrained output, or the combination of at least one constrained input and at least one constrained output.

44. The quantum computer of claim 33, wherein generating the matrix for each of the at least one gates comprises:
computing a permutation matrix for the gate;
choosing a gate matrix based on a gate type of the gate; and
multiplying a transpose of the permutation matrix, the gate matrix, and the permutation matrix to form the matrix for the gate.

45. The quantum computer of claim 33, wherein generating the final matrix comprises:
adding each matrix for each of the at least one gates together to create a circuit matrix; and
adding the constraint matrix to the circuit matrix.

46. The quantum computer of claim 33, wherein the quantum computer uses adiabatic quantum computing.

47. The quantum computer of claim 33, wherein the digital circuit represents a cryptographic function, a cryptographic algorithm, or a traveling salesman problem.

48. The quantum computer of claim 47, wherein the cryptographic function is a one-way function.
